(19) United States
(12) Patent Application Publication
(10) Pub. No.: US 2005/0270594 A1
(43) Pub. Date: Dec. 8, 2005

(54) Solid-state imaging device, method for manufacturing the same and camera

(75) Inventor: Masato Kobayashi, Kusatsu-shi (JP)

Correspondence Address: HAMRE, SCHUMANN, MUELLER & LARSON P.C., P.O. BOX 2902, MINNEAPOLIS, MN, 55402, US

(73) Assignee: Matsushita Electric Industrial Co., Ltd., Kadoma-shi (JP)

(21) Appl. No.: 11/136,193

(22) Filed: May 24, 2005

(30) Foreign Application Priority Data
May 24, 2004 (JP) 2004-153726

(51) Int. Cl. H04N 1/04

(52) U.S. Cl. 358/482

(57) ABSTRACT

A solid-state imaging device that has an on-chip filter capable of preventing color mixing from adjacent pixels due to angled light is provided at low cost. The solid-state imaging device has light receiving elements formed in a matrix pattern on a semiconductor substrate and a color filter layer that is formed on the upper layer of the light receiving elements and is constituted by color filters of three or more colors. In the color filter layer, in at least a part of a pixel border portion in which color filters of two colors are adjacent, a color filter wall of a color that is different from the two colors is provided.

### BACKGROUND OF THE INVENTION

1. Field of the Invention

The present invention relates to solid-state imaging devices that contain color on-chip filters, methods for manufacturing the same, and to cameras provided with the solid-state imaging devices.

2. Description of Related Art

Conventionally, solid-state imaging devices such as CCD solid-state imaging devices that have photo-electric conversion portions for converting light to an electric charge, and MOS solid-state imaging devices have been used in various image input apparatuses such as video cameras and digital still cameras, or facsimiles.

Color solid-state imaging devices that have color filters also are known as these solid-state imaging devices. Conventional color solid-state imaging devices have a configuration in which, for example, primary color filters made of a combination of red (R), blue (B) and green (G), or complementary color filters made of a combination of cyan (C), magenta (M), yellow (Y) and green (G) are laminated in a predetermined pattern onto light receiving faces of light receiving elements that are arranged in a two-dimensional array on the solid-state imaging elements, such that a single light receiving element corresponds to a single color. Color filters that are laminated onto the light receiving faces of light receiving elements in this way generally are called “on-chip filters”.

However, the light beams that are incident on the light receiving face of a color solid-state imaging element are not necessarily perpendicular to the light receiving surface and parallel to each other. There is a problem in that color mixing occurs when light that is incident on the light receiving face from a direction that is inclined with respect to the light receiving face passes through a single color filter at an angle and is incident on an adjacent light receiving element.

In order to solve the problem of such color mixing, a color solid-state imaging device 91 that is provided with black light blocking films 96a to 96c on border portions of light receiving pixel regions formed by photodiodes (PD) (pixel border portions), such as shown in FIG. 19, for example, has been known (for example, see JP H8-8344B (pages 3 to 4, FIGS. 1 to 3)). The color solid-state imaging device shown in FIG. 19 has been manufactured via the following steps.

Firstly, first light blocking films 96a are formed by patterning a dyeable resin to a predetermined film thickness onto the pixel border portion of the imaging surface of the solid-state imaging element 91, and dyeing with a black dye. Next, a first color filter (R) 93 is formed by patterning and dyeing a dyeable resin onto a predetermined region of the regions that are divided by the light blocking films 96a.

Next, a transparent dye repellent film 97 is formed on the light receiving face on which the first light blocking film 96a and the first color filter 93 are formed, and second light blocking films 96b are formed by patterning a dyeable resin to a predetermined film thickness onto the pixel border portion on the transparent dye repellent film 97, and dyeing with a black dye. Then, a second color filter (G) 94 is formed by patterning and dyeing a dyeable resin onto a predetermined region of the regions that are divided by the light blocking films 96b.

Moreover, in the same manner as described above, a transparent dye repellent film 98, third light blocking films 96c and a third color filter (B) 95 are formed, and lastly, a transparent dye repellent film 99 is formed as a protective layer.

In this way, by forming the black light blocking films 96a to 96c on the pixel boundary portions, light that is incident on, for example, the B color filter 95 at an angle, and that passes through this color filter is blocked by the light blocking films 96a to 96c, and is not incident on the adjacent light receiving pixel region (PD portion) 92. Thus, color mixing due to angled light can be prevented.

However, in the conventional configuration noted above, there is the problem that a multitude of steps are necessary, ie. (1) forming the black light blocking film, (2) forming the first color filter, (3) forming the dye repellent film, (4) forming the black light blocking film, (5) forming the second color filter, (6) forming the dye repellent film, (7) forming the black light blocking film, (8) forming the third color filter and (9) forming the protective layer.

### SUMMARY OF THE INVENTION

Therefore, with the foregoing in mind, it is an object of the present invention to provide a solid-state imaging device that has an on-chip filter capable of preventing color mixing from adjacent pixels due to angled light and can be made with a simpler manufacturing method.

In order to achieve the above-noted object, the solid-state imaging device according to the present invention provides a semiconductor substrate, light receiving elements that are formed in a matrix pattern on the semiconductor substrate, and a color filter layer that is formed above the light receiving elements, and that is constituted by color filters of three or more colors, wherein in the color filter layer, at least one part of a pixel border portion in which the color filters of two colors are adjacent contains a color filter wall of a color that is different from the two colors.

Furthermore, the method for manufacturing the solid-state imaging device according to the present invention provides a step of forming light receiving elements onto a semiconductor substrate in a matrix pattern, and a step of forming at least color filters of a first color to a third color in order, onto an upper layer of the light receiving elements, wherein in at least one step of the steps for forming the color filters of the first color to the third color, a color filter wall of the same color as the color filter formed in the one step is formed in at least a part of a pixel border portion in which color filters of two colors that differ from the one color filter are adjacent.

With the present invention, it is possible to provide, at a lower cost, a solid-state imaging device that has an on-chip filter capable of preventing color mixing from adjacent pixels due to angled light.

### BRIEF DESCRIPTION OF THE DRAWINGS

FIG. 1 is a plan view showing a configuration of a color filter of a solid-state imaging device according to one embodiment of the present invention.

FIG. 2A is a cross-sectional view along a line a-a′ in FIG. 1.

FIG. 2B is a cross-sectional view along a line b-b′ in FIG. 1.

FIG. 3 is a schematic view showing how angled light is incident on the solid-state imaging device according to one embodiment of the present invention.

FIG. 4 is a graph showing the spectral characteristics of the colors R, G and B.

FIG. 5 is a cross-sectional view showing one step of a method for manufacturing the solid-state imaging device according to one embodiment of the present invention.

FIG. 6 is a plan view of a mask used in one step of the method for manufacturing the solid-state imaging device according to one embodiment of the present invention.

FIG. 7A is a cross-sectional view showing one step of the method for manufacturing the solid-state imaging device according to one embodiment of the present invention.

FIG. 7B is a cross-sectional view showing one step of the method for manufacturing the solid-state imaging device according to one embodiment of the present invention.

FIG. 8A is a cross-sectional view showing one step of the method for manufacturing the solid-state imaging device according to one embodiment of the present invention.

FIG. 8B is a cross-sectional view showing one step of the method for manufacturing the solid-state imaging device according to one embodiment of the present invention.

FIG. 9 is a plan view of a mask used in one step of the method for manufacturing the solid-state imaging device according to one embodiment of the present invention.

FIG. 10A is a cross-sectional view showing one step of the method for manufacturing the solid-state imaging device according to one embodiment of the present invention.

FIG. 10B is a cross-sectional view showing one step of the method for manufacturing the solid-state imaging device according to one embodiment of the present invention.

FIG. 11A is a cross-sectional view showing one step of the method for manufacturing the solid-state imaging device according to one embodiment of the present invention.

FIG. 11B is a cross-sectional view showing one step of the method for manufacturing the solid-state imaging device according to one embodiment of the present invention.

FIG. 12A is a cross-sectional view showing another example of the color filter of the solid-state imaging device of the present invention.

FIG. 12B is a cross-sectional view showing another example of the color filter of the solid-state imaging device of the present invention.

FIG. 13A is a cross-sectional view showing another example of the color filter of the solid-state imaging device of the present invention.

FIG. 13B is a cross-sectional view showing another example of the color filter of the solid-state imaging device of the present invention.

FIG. 14A is a cross-sectional view showing one step of the manufacturing method for forming the color filter in FIG. 12A.

FIG. 14B is a cross-sectional view showing one step of the manufacturing method for forming the color filter in FIG. 12A.

FIG. 15 is a cross-sectional view showing one step of the manufacturing method for forming the color filter in FIG. 13A.

FIG. 16 is a graph showing the spectral characteristics of the colors C, M, Y and G.

FIG. 17A is a plan view showing another example of the configuration of the color filter of the solid-state imaging device according to one embodiment of the present invention.

FIG. 17B is a plan view showing another example of the configuration of the color filter of the solid-state imaging device according to one embodiment of the present invention.

FIG. 17C is a plan view showing another example of the configuration of the color filter of the solid-state imaging device according to one embodiment of the present invention.

FIG. 18 is a block diagram showing a structural overview of a camera according to one embodiment of the present invention.

FIG. 19 is a cross-sectional view showing one example of the configuration of a conventional color solid-state imaging device.

### DETAILED DESCRIPTION OF THE INVENTION

The solid-state imaging device according to the present invention is constituted by a semiconductor substrate, light receiving elements that are formed in a matrix pattern on the semiconductor substrate, and a color filter layer that is formed above the light receiving elements, and that is constituted by color filters of three or more colors, wherein in the color filter layer, at least one part of a pixel border portion in which the color filters of two colors are adjacent contains a color filter wall of a color that is different from the two colors.

With this configuration, when angled light that has passed through a color filter of a pixel is incident on a color filter wall, the colors of the color filter and the color filter wall are different and thus there is the effect that the angled light is eliminated. Thus, color mixing from adjacent pixels due to angled light can be prevented. The manufacturing step is simplified because conventional black light blocking films are unnecessary, and it is possible to provide the solid-state imaging device at lower cost.

In the solid-state imaging device having the above-noted configuration, the color filter layer can be constituted by, for example, color filters in a primary color Bayer pattern, color filters in a primary color stripe array, or color filters having complementary colors.

In the solid-state imaging device having the above-noted configuration, if the color filter layer has a configuration in which it is formed by a colored photoresist, then the solid-state imaging device can be manufactured without a step of dyeing, and thus it is possible to reduce the manufacturing cost further.

The solid-state imaging device having the above-noted configuration may be embodied such that the color filter wall has substantially the same thickness as the color filter layer, and is formed with a substantially uniform width. Furthermore, the solid-state imaging device having the above-noted configuration may be embodied such that the color filter wall is formed with a thickness that is lower than that of the color filter layer. Alternatively, it may be embodied such that the width of the color filter wall decreases toward the side of the color filter layer on which the light is incident. With the latter two aspects, there is the advantage that it is possible to ensure that the area of the pixel aperture is broad, while preventing color mixing due to angled light.

The present invention may also be embodied as a camera provided with the solid-state imaging device having any of the configurations noted above.

The method for manufacturing the solid-state imaging device according to the present invention includes a step of forming light receiving elements onto a semiconductor substrate in a matrix pattern, and a step of forming at least color filters of a first color to a third color in order, onto an upper layer of the light receiving elements, wherein in at least one step of the steps for forming the color filters of the first color to the third color, a color filter wall of the same color as the color filter formed in the one step is formed in at least a part of a pixel border portion in which color filters of two colors that differ from the one color filter are adjacent.

With this manufacturing method, it is possible to manufacture a solid-state imaging device that can prevent color mixing from adjacent pixels due to angled light. That is to say, in this solid-state imaging device, when angled light that has passed through a pixel of a color filter is incident on a color filter wall, the colors of the color filter and the color filter wall are different, and thus there is the effect that the angled light is eliminated. Thus, color mixing due to angled light can be prevented. Further, the manufacturing step is simplified because the color filter wall can be formed in the same step as the color filter of the same color and the step of forming conventional black light blocking films are unnecessary, and it is possible to provide the solid-state imaging device at lower cost.

In the manufacturing method noted above, the color filter and the color filter wall can be formed by photolithography. In this case, it is preferable that a colored photoresist is used as the material of the color filter and the color filter wall. This is because the manufacturing step can be further simplified, because a step of dyeing is not necessary. Moreover, by using a halftone mask or a grey tone mask when forming the color filter wall, it is possible to form a color filter wall having a thickness that is lower than that of the color filter layer, or a color filter wall whose width decreases toward the side of the color filter layer on which the light is incident.

The aforementioned manufacturing method may also include a step of using a dyeable resin as the material of the color filter and the color filter wall, and patterning the dyeable resin, and a step of dyeing the patterned dyeable resin. In this case, it is preferable that the aforementioned manufacturing method also includes a step of treating with a hardening liquid after the step of dyeing the dyeable resin. This is because the manufacturing step can be simplified since a dye repellent film is unnecessary, and it is possible to make the on-chip filter thinner.

More specific embodiments of the solid-state imaging device of the present invention are described below with reference to the drawings.

### Embodiment 1

A solid-state imaging device according to one embodiment of the present invention is described below. It should be noted that a CCD solid-state imaging device is illustrated here as one embodiment, however the present invention is not limited to CCD solid-state imaging devices, and may also be applied to, for example, MOS solid-state imaging devices.

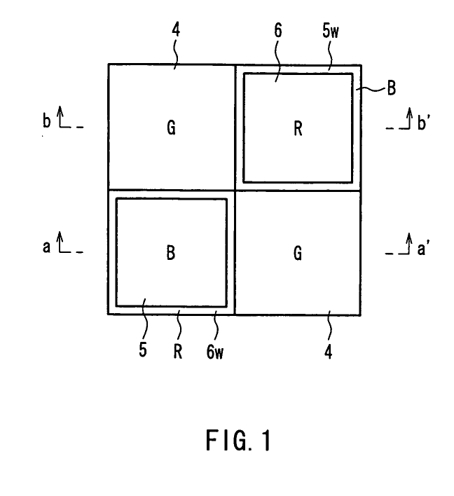

The solid-state imaging device according to the present embodiment has a color filter layer that is in what is known as a basic Bayer pattern, in which G color filters 4 are arranged on two diagonally opposite pixels of four 2 (h)×2 (w) pixels, wherein an R color filter 6 is arranged on one pixel of the remaining two pixels, and a B color filter 5 is arranged on the further remaining one pixel, such as shown in FIG. 1. However, there is a B color filter wall 5w on the border (pixel border region) of the G color filter 4 and the R color filter 6, and there is an R color filter wall 6w on the border (pixel border region) of the G color filter 4 and the B color filter 5.

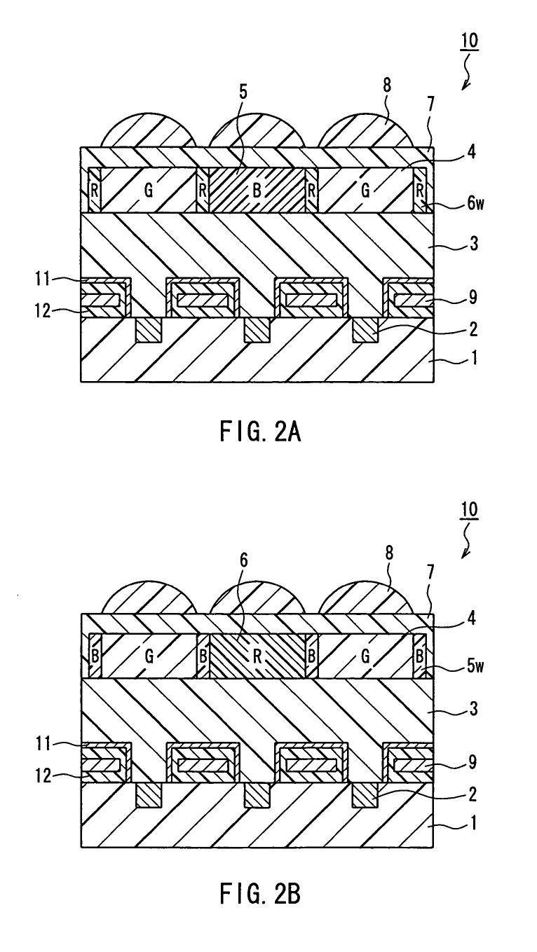

FIG. 2A is a cross-sectional view along a line a-a′ in FIG. 1, and FIG. 2B is a cross-sectional view along a line b-b′ in FIG. 1. It should be noted that FIG. 2A and FIG. 2B show a configuration of three pixels worth of width in the row direction, so that the relationships between adjacent pixels may be understood easily.

As shown in FIG. 2A and FIG. 2B, a solid-state imaging device 10 according to the present embodiment contains a semiconductor substrate 1, a plurality of photodiodes 2 that are formed in a matrix pattern on the semiconductor substrate 1, and transfer electrodes 9. The transfer electrodes 9 are arranged on the semiconductor substrate 1 so as to be adjacent to the photodiodes 2 via insulating films 12. Light blocking films 11 for preventing the incidence of light onto the transfer electrodes 9 are provided on the upper surfaces of the transfer electrodes 9 and the insulating films 12. A first flat film 3 made of a transparent acrylic resin, for example, is provided above the semiconductor substrate 1 on which the photodiodes 2 and the transfer electrodes 9 are formed.

A color filter layer is formed above the first flat film 3. As can be understood from FIG. 2A, for the color filter layer, in the Gb row of the Bayer pattern, the G color filter 4 and the B color filter 5 are provided alternately above the first flat film 3, aligned with the positions of the respective photodiodes 2. Moreover, the R color filter walls 6w are provided on the borders of the G color filter 4 and the B color filter 5. The R color filter walls 6w have the same thickness as the G color filters 4 and the B color filters 5, and they have uniform width.

As can be understood from FIG. 2B, in the Gr row of the Bayer pattern, the G color filter 4 and the R color filter 6 are provided alternately on the upper layer of the first flat film 3, aligned with the positions of the respective photodiodes 2. Moreover, the B color filter walls 5w are provided on the borders of these G color filters 4 and the R color filter 6. The B color filter walls 5w have the same thickness as the G color filters 4 and the R color filter 6, and they have uniform width.

Moreover, a second flat film 7 made from transparent acrylic resin, for example, is provided above the color filter layer made up of the G color filters 4, the B color filter 5, the R color filter 6, the R color filter walls 6w and the B color filter walls 5w described above. Microlenses 8 for focusing incident light onto the photodiodes 2 then are provided above the second flat film 7, aligned with the positions of the respective photodiodes 2.

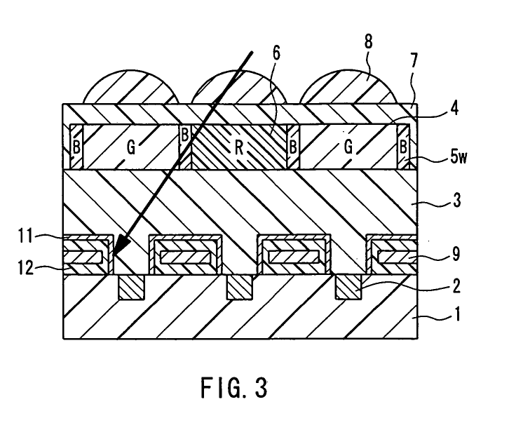

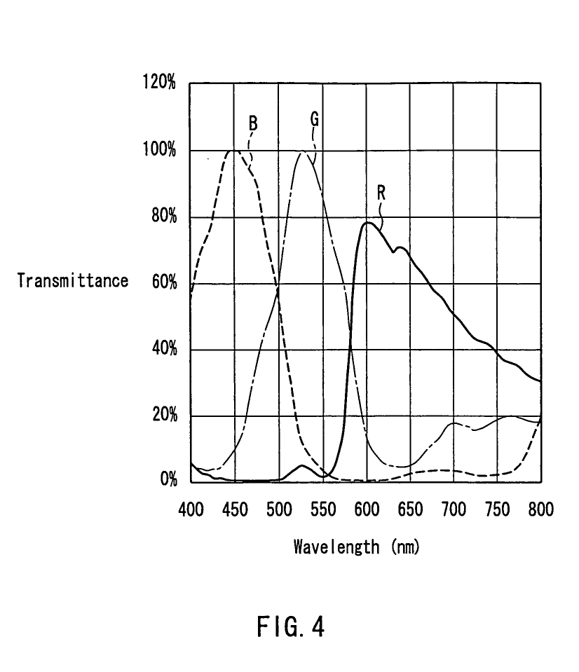

FIG. 3 and FIG. 4 are hereby used to describe the case in which angled light is incident on the solid-state imaging device 10 according to the configuration noted above. The case in which light that has passed through the R color filter 6 is incident on the photodiode 2 directly below the G color filter 4, as shown in FIG. 3, for example, is considered. In this case, the angled light that has passed through the R color filter 6 also passes through the B color filter wall 5w that is provided next to the color filter 6. FIG. 4 shows the transmittance of light of the colors R, G and B. As shown in FIG. 4, whereas the transmittance of R light at a wavelength of 550 nm or less is substantially 0%, the transmittance of B light is substantially 0% at a wavelength of 550 nm or more. If light of different colors is mixed, then the spectral characteristic of the mixed light is the product of the transmittance of the individual colored lights. Consequently, the transmittance of the angled light that that has passed through the R color filter 6 and the B color filter wall 5w, such as shown in FIG. 3, is substantially 0% in all wavelength regions. Therefore, no significant color mixing occurs in the photodiode 2 that is directly below the G color filter 4, in which the above-mentioned angled light is a factor.

Furthermore, since the overlap of the transmittance curves of the G light and the R light is small, as shown in FIG. 4, in FIG. 3, the transmittance of angled light that has passed through the G color filter 4, for example, and is incident on the photodiode 2 that is directly below the R color filter 6 is also substantially 0%, with the exception of one part of the wavelength region (550 to 600 nm and 650 to 800 nm). Even within the wavelength regions 550 to 600 nm, and 650 to 800 nm, the transmittance of mixed color is exceedingly small.

In the same way, the transmittance of the angled light that has passed through the G color filter 4 and the adjacent B color filter 5w, as shown in FIG. 2B, also is reduced significantly, as can be seen in FIG. 4.

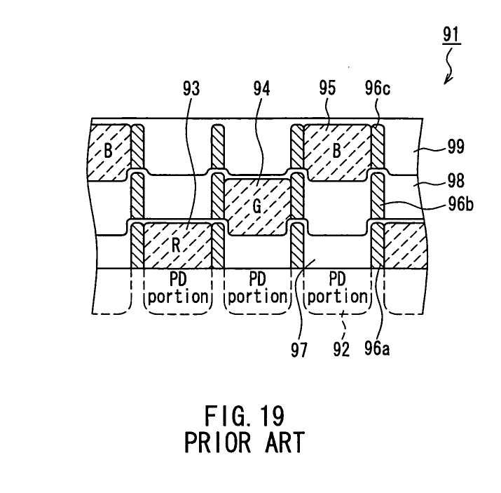

As given above, color mixing from adjacent pixels due to angled light can be prevented effectively in the solid-state imaging device 10. Furthermore, in the solid-state imaging device 10, the R, G and B color filters 4, 5 and 6, and the color filter walls 5w and 6w are formed as a single layer color filter layer having a uniform thickness. Therefore it is possible to make the on-chip filter thinner than that of a conventional configuration in which the R, G, and B color filters are formed as a plurality of layers, such as shown in FIG. 19, and there is the advantage of increased sensitivity.

A method for manufacturing the solid-state imaging device 10 according to the present embodiment is described next.

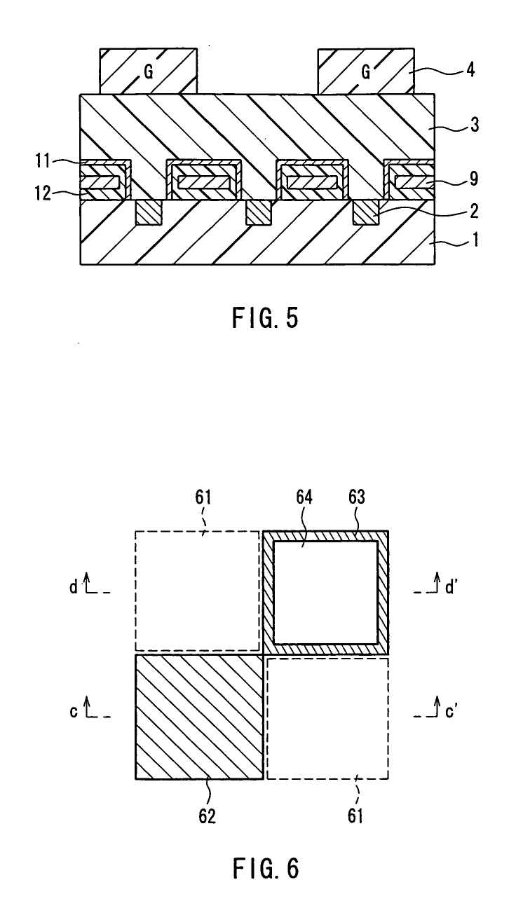

Firstly, as shown in FIG. 5, the photodiodes 2, the insulating films 12, the transfer electrodes 9 and the light blocking films 11 are formed by a known method onto the semiconductor substrate 1, after this, an acrylic resin is coated onto the entire face by spin coating, and then is heated and dried to form the first flat film 3. After which the G color filters 4 are formed on the surface of the first flat film 3. In this case, the G color filters 4 are arranged alternately in the row direction and alternately in the column direction corresponding to the photodiodes 2 that are formed in a matrix pattern on the semiconductor substrate 1. That is to say, the G color filters 4 are arranged so as to form a checkerboard pattern on the light receiving face. It should be noted that the G color filters 4 may be formed by, for example, coating a positive photoresist that has been colored green onto the surface of the first flat film 3 such that the thickness is uniform, masking such that the regions other than the locations that are to form the color filters 4 are exposed, irradiating with light and then developing.

Next, a positive photoresist that has been colored blue is coated by spin coating so as to cover the entirety of the G color filter 4s and the first flat film 3. A mask having a pattern such as is shown in FIG. 6 is arranged above the blue positive photoresist. In this case, the mask is aligned such that the region of the mask having no pattern (regions 61 in FIG. 6 shown by dashed lines) coincides with the position of the G color filters 4.

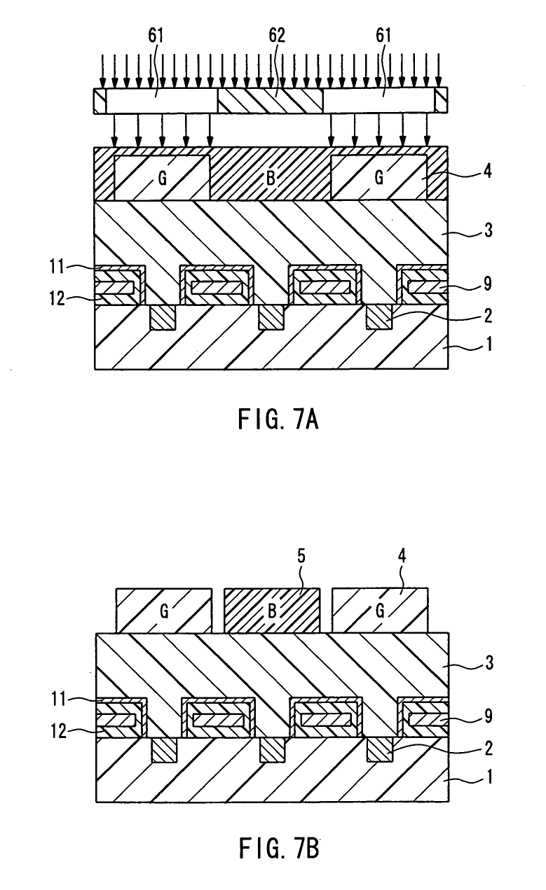

When light is irradiated from above the mask in this condition, in a cross-section c-c′ shown in FIG. 6 the photoresist directly below the non-patterned regions 61 of the mask is exposed by the light that passes through the regions 61, as shown in FIG. 7A. On the other hand, for the photoresist in the part corresponding to the mask region 62 of the mask of FIG. 6, the light is blocked by the mask region 62, and thus the photoresist is not exposed. Consequently, in the cross-section c-c′ shown in FIG. 6, when the photoresist is developed the B color filter is 5 is formed because the blue photoresist remains only in the locations corresponding to the mask region 62, as shown in FIG. 7B.

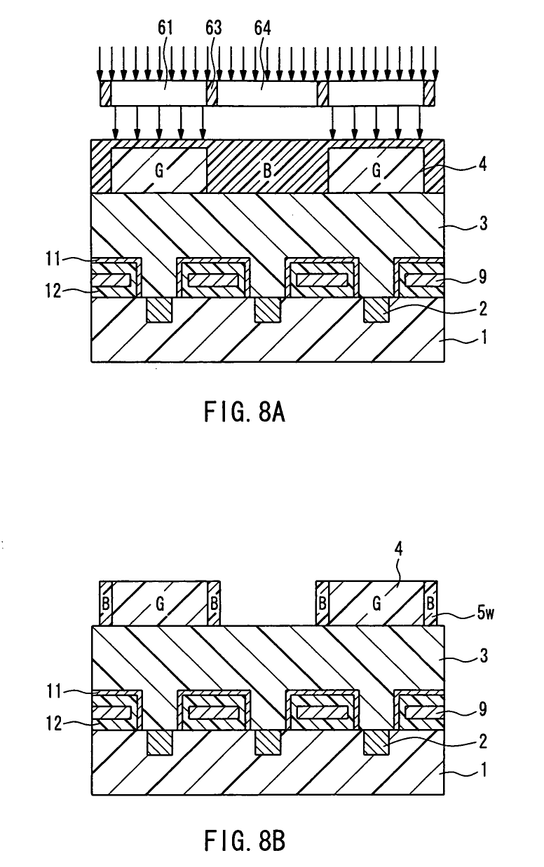

In a cross-section d-d′ shown in FIG. 6, the photoresist directly below regions 61 and 64 of the mask that have no pattern (see FIG. 6) is exposed by the light that passes through the regions 61 and 64 respectively, as shown in FIG. 8A. On the other hand, for the part of the photoresist that corresponds to a mask region 63 of the mask in FIG. 6, the light is blocked by the mask region 63, and thus the photoresist is not exposed. Consequently, in the cross-section d-d′ shown in FIG. 6, when the photoresist is developed the B color filter walls 5w are formed adjacent to the G color filters 4 because the blue photoresist remains only in the locations corresponding to the mask region 63, as shown in FIG. 8B.

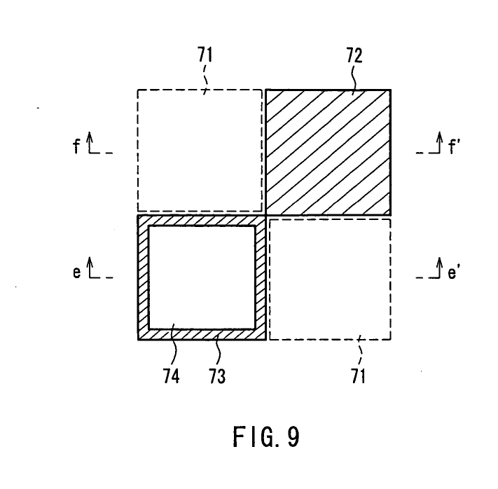

Next, a positive photoresist that has been colored red is spin coated so as to cover the entirety of the G color filters 4 and the B color filter 5, and the color filter walls 5w that are formed as shown in FIG. 7B and FIG. 8B. A mask having a pattern such as shown in FIG. 9 is then arranged above the red positive photoresist. In this case, the mask is aligned such that the region of the mask having no pattern (regions 71 in FIG. 9 shown by dashed lines) coincides with the position of the G color filters 4.

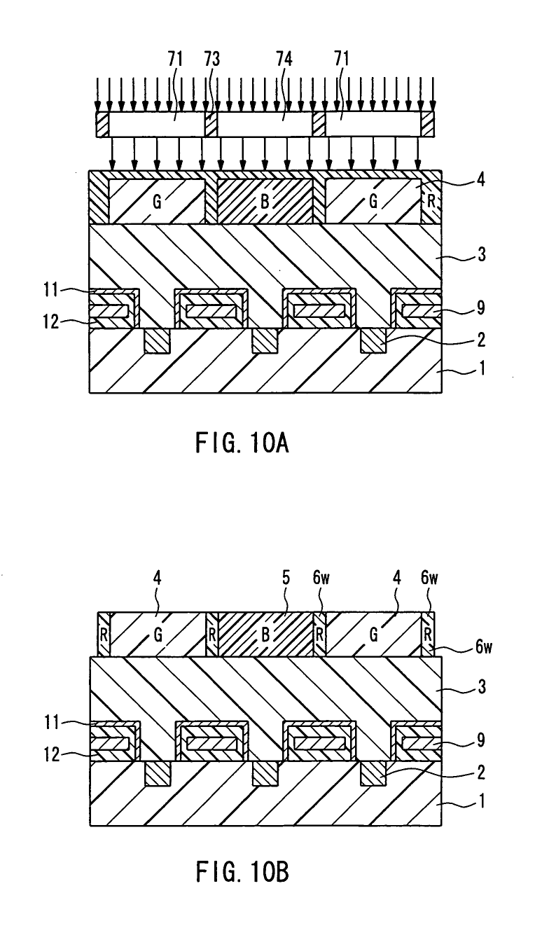

When light is irradiated from above the mask in this condition, in a cross-section e-e′ shown in FIG. 9 the photoresist directly below the non-patterned regions 71 and 74 (see FIG. 9) of the mask is exposed by the light that passes through the regions 71 and 74 respectively, as shown in FIG. 10A. On the other hand, for the photoresist in the part corresponding to a mask region 73 of the mask of FIG. 9, the light is blocked by the mask region 73, and thus the photoresist is not exposed. Consequently, in the cross-section e-e′ shown in FIG. 9, when the photoresist is developed the R color filter walls 6w are formed on the border of the G color filters 4 and the B color filter 5 because the red photoresist remains only in the locations corresponding to the mask region 73, as shown in FIG. 10B.

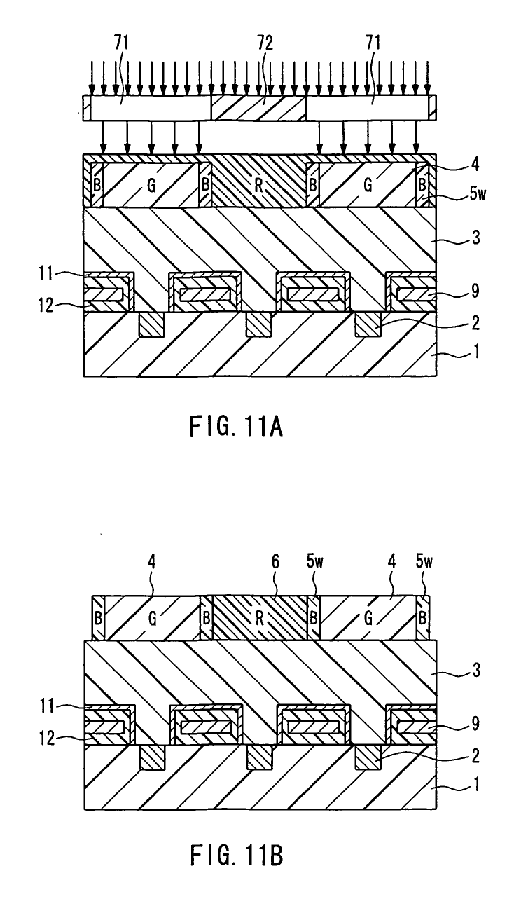

Furthermore, in a cross-section f-f′ shown in FIG. 9, the photoresist directly below the non-patterned regions 71 of the mask is exposed by the light that passes through the regions 71, as shown in FIG. 11A. On the other hand, for the part of the photoresist that corresponds to a mask region 72 of the mask in FIG. 9, the light is blocked by the mask region 72, and thus the photoresist is not exposed. Consequently, in the cross-section f-f′ shown in FIG. 9, when the photoresist is developed the R color filter 6 is formed because the red photoresist remains only in the locations corresponding to the mask region 72, as shown in FIG. 11B.

Continuing, the second flat film 7 is formed on the color filter layer that is formed as shown in FIG. 10B and FIG. 11 B by coating acrylic resin by spin coating, and then heating and drying. Moreover, the solid-state imaging device 10 having the structure shown in FIG. 2A and FIG. 2B is completed by forming the microlenses 8 onto the surface of the second flat film 7. There is no particular limitation on the manner of forming the second flat film 7 and microlenses 8.

With the manufacturing method given above, the color filter layer can be formed by the three steps of (1) forming the G color filters, (2) forming the B color filter and the color B filter walls, and (3) forming the R color filter and the R color filter walls. Therefore, the manufacturing step can be made simpler than the conventional configuration that contains black light blocking films in the pixel border regions, as described previously.

It should be noted that the above-noted manufacturing method is no more than a single example, and that various alternatives are possible. For example, in this case, an example has been shown in which the color filters are formed in the order of G, B and R, however the order in which the color filters are formed is not limited to this, and may be any order desired. Furthermore, a negative photoresist may also be used as a substitute for the positive photoresist. In this case, the pattern of the mask may be altered such that the regions that allow light to pass and the regions that block the light are the opposite of those in FIG. 6 and FIG. 9.

Furthermore, a dyeable resin or the like may be used as the material for the color filter layer, as a substitute for the colored resist described above. In this case, a transparent dyeable resin is first patterned to the shape of any color filter (for example, G), after which it is dyed with dye. After forming a dye repellent film thereon, the transparent dyeable resin is again patterned to the shape of the color filter and the color filter walls, and dyed with the next color (for example, B). Then, after forming the dye repellent film thereon, the transparent dyeable resin further is patterned to the shape of the color filter and the color filter walls, and dyed with the next color (for example, R).

If a dyeable resin is used, then a step of treating with a hardening liquid may be added after the dying step as a substitute for using the dye repellent film described above. In this case, the dyeable resin treated with the hardening liquid will not be colored even if later exposed to other dyes. Thus the dye-repellent film is unnecessary and there is the advantage that the color filter layer does not become thick.

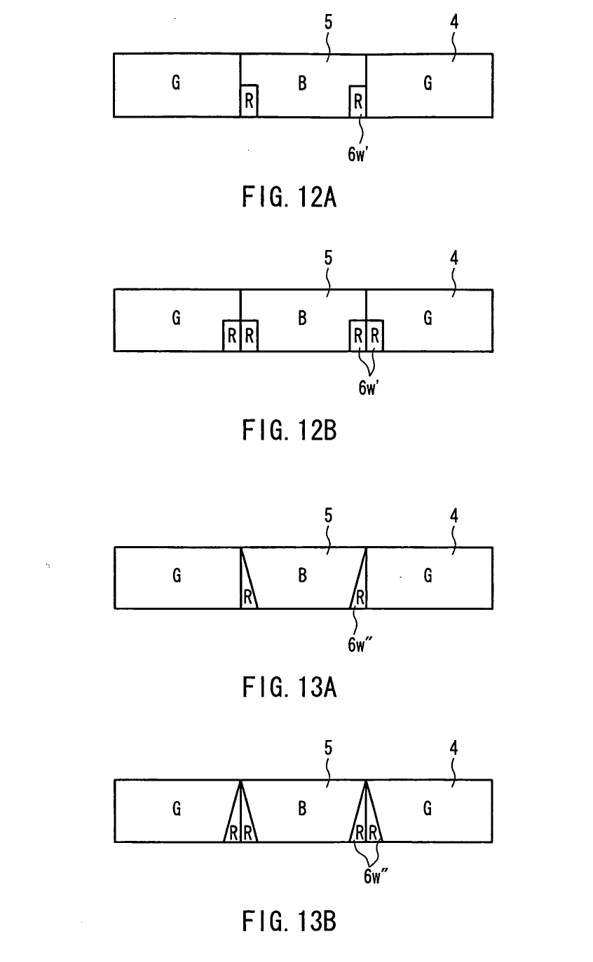

The R or B color filter walls 5w or 6w shown in FIG. 2A and FIG. 2B have the same thickness as the thickness of the color filter layer, and their widths are substantially uniform. However, the color filter walls of the present invention are not limited to just this specific example. It is sufficient that the color filter walls are formed on at least a part of the pixel border portion. For example, it is possible to achieve the effect of preventing color mixing due to angled light from an adjacent pixel even with a configuration such as shown in FIG. 12A, FIG. 12B, FIG. 13A and FIG. 13B.

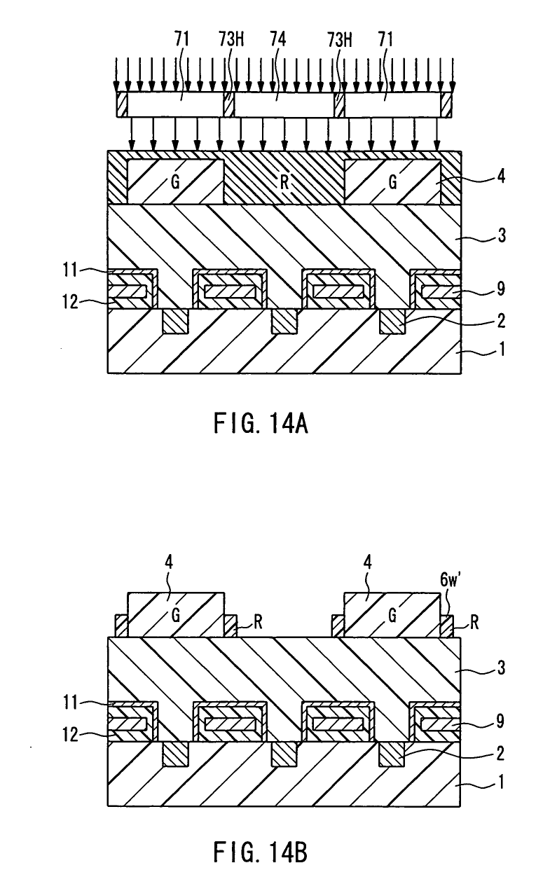

Color filter walls 6w′ shown in FIG. 12A are formed such that their thickness is about half the thickness of the color filter layer. Such color filter walls can be formed by using a halftone mask 73H, such as is shown in FIG. 14A, as the mask for the locations at which the color filter walls are to be formed. It should be noted that the mask shown in FIG. 14A is a mask in which the part denoted by the numeral 73 in the mask shown in FIG. 9 is set to be the halftone mask 73H. A halftone mask is a mask in which the transmittance of light is approximately 50%. As shown in FIG. 14B, by exposing the photoresist using this mask, and then developing, approximately the top half of the resist in the region that is covered by the halftone mask 73H is removed to form the color filter walls 6w′ that have a thickness of about half the thickness of the color filter layer. It should be noted that the thickness of the color filter walls is not limited to about half the color filter layer, and color filter walls having any thickness may be formed by, for example, adjusting the transmittance of the mask or the exposure time period.

It should be noted that in FIG. 12A, the color filter walls 6w′ are arranged such that they overlap with the B color filter 5 in the pixel border portion of the G color filters 4 and the B color filters 5, however they may also be arranged such that, conversely, they overlap with the G color filters 4. Furthermore, as shown in FIG. 12, the color filter walls 6w′ that are lower than the thickness of the color filter layer also may be formed such that they straddle the pixel border, that is, such that they overlap both the G color filter 4 and the B color filter 5.

Furthermore, the width of the color filter walls may also be non-uniform. For example, the width of the color filter walls 6w″ as shown in FIG. 13A may decrease as the width of the color filter walls 6w″ approaches the upper layer (the side on which the light is incident) of the color filter layer. With such a configuration, it is possible to ensure that the aperture of the color filter is wide while effectively preventing color mixing due to angled light incident on adjacent pixels.

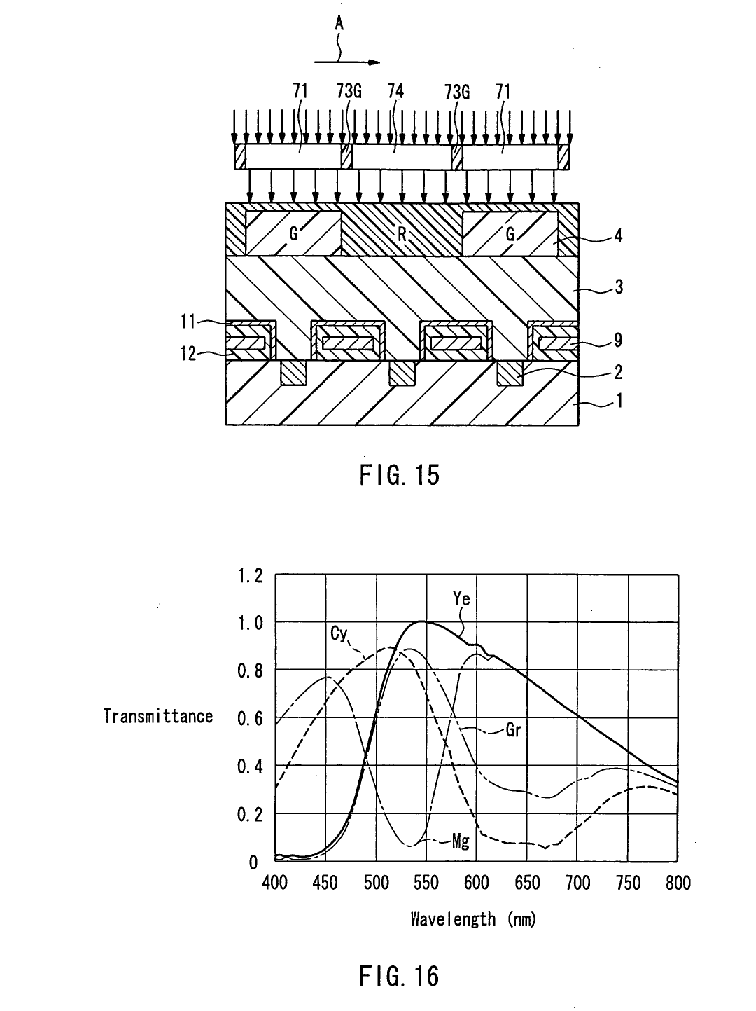

It should be noted that the color filter walls 6w″ shown in FIG. 13A may be formed by using a grey tone mask 73G as shown in FIG. 15, as the mask for the locations in which the color filter wall is to be formed. It should be noted that the mask shown in FIG. 15 is a mask in which the part of the mask denoted by the numeral 73 shown in FIG. 9 is set to be the grey tone mask 73G. A grey tone mask is a mask in which the transmittance of light partially differs. In order to form the color filter wall 6w″ shown in FIG. 13A, it is possible to use a mask, in which the transmittance gradually increases in the direction of an arrow A shown in FIG. 15, as the grey tone mask 73G.

It is preferable that the angled faces of the color filter walls 6w″ are formed at an angle at which the light that is incident perpendicular to the light receiving face and that is focused with the microlenses 8 toward the photodiodes 2 is not incident on the color filter walls 6w″.

In FIG. 13A, the color filter walls 6w″ are arranged such that they overlap with the B color filter 5 on the pixel border portions of the G color filter 4 and the B color filter 5, however the color filter walls 6w″ also may be arranged such that, conversely, they overlap with the G color filters 4. Furthermore, as shown in FIG. 13B, the color filter walls 6w″, whose width decreases toward the upper layer side (the side on which the light is incident) of the color filter layer, may be formed such that they straddle the pixel border, that is, such that they overlap both the G color filter 4 and the B color filter 5.

In the above-noted description, a configuration has been illustrated in which the basic array of the color filter is a primary color Bayer pattern, however, the present invention also may be applied to a case in which the color filter is a striped array of three primary colors. In this case also, the B, G and R color filter walls may be arranged on the R and G pixel border portion, the R and B pixel border portion and the G and B pixel border portion respectively.

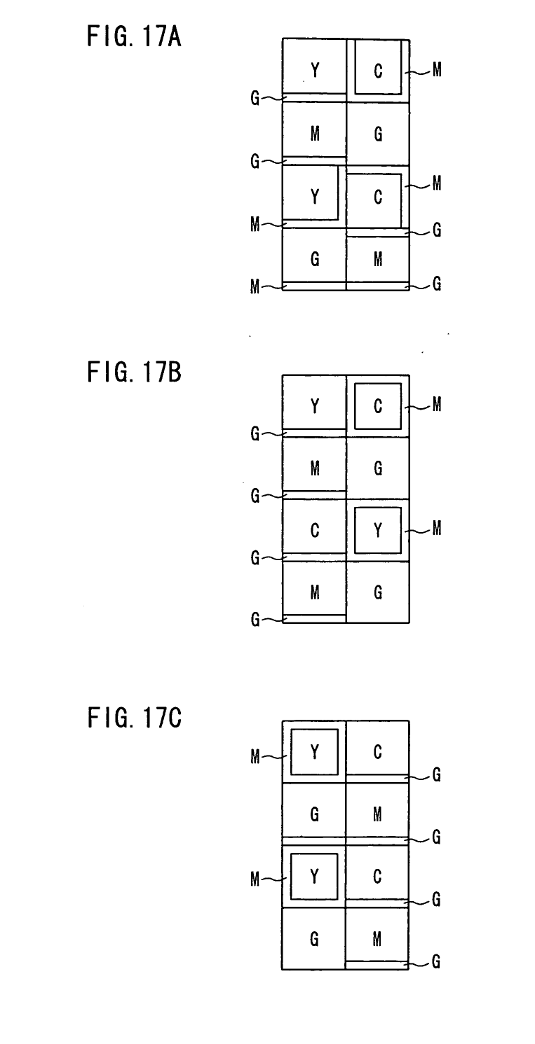

Moreover, it is also possible to embody the present invention with complementary color filters. The spectral characteristics of the colors C, M, Y and G are as shown in FIG. 16. Therefore, it is preferable that M, G, G, M and M color filter walls are arranged on the Y and C pixel border portion, the Y and M pixel border portion, the C and M pixel border portion, the Y and G pixel border portion and the G and C pixel border portion respectively. It should be noted that it is not necessary to provide a color filter wall on the G and M pixel border portion. Consequently, color filters and color filter walls may be provided as shown in FIG. 17A to FIG. 17C, for example.

### Embodiment 2

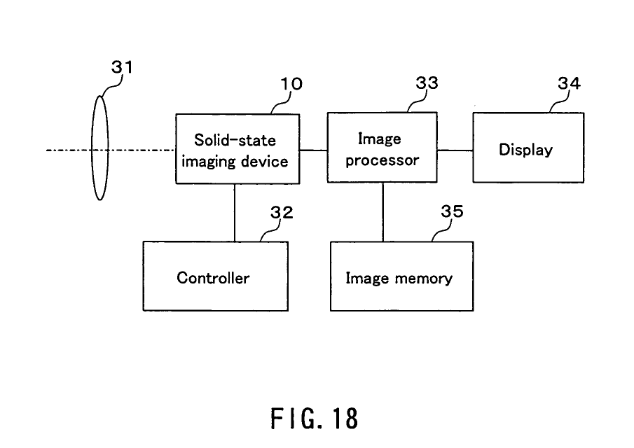

Another embodiment of the present invention is described with reference to FIG. 18.

If the solid-state imaging device described in Embodiment 1 is applied to a digital camera, then a digital camera that has superior picture quality due to prevention of color mixing can be realized at low cost. FIG. 18 is a block diagram showing a structural overview of the camera according to the present embodiment. As shown in FIG. 18, the camera according to the present embodiment is provided with, for example, a solid-state imaging element 10, an optical system 31 that includes lenses and the like for forming an image from the light that is incident from the object to be photographed on the imaging surface of the solid-state imaging device 10, a controller 32 for controlling the drive of the solid-state imaging device 10, an image processor 33 for processing various signals that are output from the solid-state imaging device 10, a display 34 for displaying the image signals that are processed in the image processor 33, and an image memory 35 for storing the image signals that are processed by the image processor 33. It should be noted that the camera may be any one of a still camera that is only capable of taking still images; a video camera that is capable of taking animated images; or a camera that is capable of taking both still images and animated images.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A solid-state imaging device comprising:
a semiconductor substrate;
light receiving elements that are formed in a matrix pattern on the semiconductor substrate; and
a color filter layer that is formed above the light receiving elements, and that is constituted by color filters of three or more colors,
wherein in the color filter layer, at least one part of a pixel border portion in which the color filters of two colors are adjacent contains a color filter wall of a color that is different from the two colors.

2. The solid-state imaging device according to claim 1,
wherein the color filter layer is constituted by color filters in a primary color Bayer pattern.

3. The solid-state imaging device according to claim 1,
wherein the color filter layer is constituted by color filters in a primary color stripe array.

4. The solid-state imaging device according to claim 1,
wherein the color filter layer is constituted by complementary color filters.

5. The solid-state imaging device according to claim 1,
wherein the color filter layer comprises a photoresist that has been colored.

6. The solid-state imaging device according to claim 1,
wherein the color filter wall has a thickness that is substantially the same as that of the color filter layer, and is formed with a substantially uniform width.

7. The solid-state imaging device according to claim 1,
wherein the color filter wall is formed with a thickness that is lower than that of the color filter layer.

8. The solid-state imaging device according to claim 1,
wherein the color filter wall is formed such that the width of the color filter wall decreases toward the side of the color filter layer on which light is incident.

9. A method for manufacturing a solid-state imaging device comprising the steps of:
forming light receiving elements in a matrix pattern on a semiconductor substrate; and
forming at least color filters of a first color to a third color in order, above the light receiving elements,
wherein in at least one sub-step of the steps of forming the color filters of the first color to the third color, a color filter wall of the same color as a color filter formed in the one sub-step is formed in at least a part of a pixel border portion in which color filters of two colors that differ from said color filter formed in the one sub-step are adjacent.

10. The method for manufacturing a solid-state imaging device according to claim 9,
wherein the color filters and the color filter walls are formed by photolithography.

11. The method for manufacturing a solid-state imaging device according to claim 10,
wherein a photoresist that has been colored is used as the material of the color filters and the color filter walls.

12. The method for manufacturing a solid-state imaging device according to claim 10,
wherein a halftone mask or a grey tone mask is used when forming the color filter wall.

13. The method for manufacturing a solid-state imaging device according to claim 9, further comprising the steps of:
using a dyeable resin as the material of the color filters and the color filter walls, and patterning the dyeable resin; and
dyeing the patterned dyeable resin.

14. The method for manufacturing a solid-state imaging device according to claim 13, further comprising the step of:
treating with a hardening liquid after the step of dyeing the dyeable resin.

15. A camera that is provided with the solid-state imaging device according to claim 1.
